(19) United States
(12) Patent Application Publication
(10) Pub. No.: US 2024/0283557 A1
(43) Pub. Date: Aug. 22, 2024

(54) WAVELENGTH CROSS CONNECT DEVICE, AND WAVELENGTH CROSS CONNECT METHOD

(71) Applicant: Nippon Telegraph and Telephone Corporation, Tokyo (JP)

(72) Inventors: Masahiro NAKAGAWA, Musashino-shi, Tokyo (JP); Hiroki KAWAHARA, Musashino-shi, Tokyo (JP); Takeshi SEKI, Musashino-shi, Tokyo (JP)

(21) Appl. No.: 18/567,818

(22) PCT Filed: Jun. 7, 2021
(86) PCT No.: PCT/JP2021/021587

§ 371 Date: Dec. 7, 2023

(51) Int. Cl. H04J 14/02; H04B 10/291

(52) U.S. Cl. CPC H04J 14/0213; H04B 10/291

(57) ABSTRACT

A wavelength cross-connect device includes a first conversion module that converts a first wavelength band (S-band) shorter than a specific wavelength band (C-band) into an optical signal of the specific wavelength band and converts the specific wavelength band from a WXC unit into an optical signal of a second wavelength band (L-band) longer than the specific wavelength band, among the respective wavelength bands demultiplexed by a demultiplexing unit and a second conversion module that converts the second wavelength band into an optical signal of the specific wavelength band and converts the specific wavelength band from the WXC unit into an optical signal of the first wavelength band. The optical signal of the specific wavelength band converted by the first/second conversion unit is output to the WXC unit, and the optical signal of the first/second wavelength band is output to a multiplexing unit.

### TECHNICAL FIELD

The present invention relates to a wavelength cross-connect device and a wavelength cross-connect method to be used for multiband transmission in which multiple wavelength signal light obtained by multiplexing respective optical signals in different wavelength bands is transmitted through optical fibers.

### BACKGROUND ART

A wavelength cross-connect device that is used in a multiband transmission system is an optical node that connects between desired paths of an optical transmission line in an optical network, wherein the optical transmission line is formed with one or a plurality of optical fibers or a multicore fiber that transmits multiple wavelength signal light obtained by multiplexing respective optical signals in different wavelength bands. In this wavelength cross-connect device, multiple wavelength signal light transmitted from a path on an input side is output to a desired path on an output side via a plurality of wavelength selective switches (WSSs).

A conventional wavelength cross-connect device first demultiplexes optical signals of respective wavelength bands of multiple wavelength signal light transmitted in multiple bands in respective M paths on the input side using wavelength band demultiplexing units connected to the respective paths. For example, optical signals of the respective wavelength bands of the S-band, the C-band, and the L-band multiplexed into the multiple wavelength signal light are demultiplexed.

Here, the respective wavelength bands are the S-band of 1460 nm to 1530 nm, the C-band of 1530 nm to 1565 nm, and the L-band of 1565 nm to 1625 nm, in ascending order from the short-wavelength band. The respective optical signals in the S-band, the C-band, and the L-band are allocated to paths of the S-band, the C-band, and the L-band of the optical fibers at a time of transmission.

The optical signals of the wavelength bands (the S-band and the L-band) other than a specific wavelength band (for example, the C-band) among the above-described demultiplexed optical signals of the respective wavelength bands: the S-band, the C-band, and the L-band are converted into optical signals of the specific wavelength band by wavelength band conversion units on the input side, and are input to a wavelength cross connect (WXC) unit. Meanwhile, the optical signals of the specific wavelength band on the input side are input directly to the WXC unit.

The WXC unit performs the following relay process: a plurality of optical signals of the specific wavelength band to be input to the WXC unit are input through a plurality of input ports of contention WSSs on the input side, and are output through a plurality of output ports to a plurality of input ports of contention WSSs on the output side to be subjected to predetermined processing, and then output through a plurality of output ports from the WXC unit. In this manner, the WXC unit performs a relay process on the optical signals of the specific wavelength band that is the identical wavelength band.

The optical signals of the specific wavelength band after subjected to the relay process are, if they are optical signals converted by the wavelength band conversion units on the input side, converted to the original signals before the conversion by wavelength band conversion units on the output side, and output. The optical signals of the specific wavelength band that have been input directly through the input side without passing through the wavelength band conversion units on the input side are directly output after being subjected to the relay process at the WXC unit. These output wavelength bands are output to the respective paths, after multiplexed by wavelength band multiplexing units connected to respective M paths on the output side. Such a relay process causes the WXC unit to process only optical signals of the single wavelength band (the specific wavelength band), and thus is able to eliminate differences in optical characteristics due to differences among the wavelength bands in multiband transmission.

Non Patent Literature 1 (NPL 1) discloses a conventional technology relating to this kind of wavelength cross-connect device.

### CITATION LIST

### Non Patent Literature

[NPL1]: H. Kawahara, et al., “Experimental demonstration of wavelength-selective band/direction-switchable multi-band OXC using an inter-band all-optical wavelength converter”, Proc. ECOC 2020, paper TulH-5, December 2020.

### SUMMARY OF INVENTION

### Technical Problem

The conventional wavelength cross-connect device described above, however, needs to connect M×2 wavelength band conversion units to each of the M wavelength band demultiplexing units on the input side (that is, a total of M×(M×2) wavelength band conversion units), and to connect M×2 wavelength band conversion units to each of the M wavelength band multiplexing units on the output side (a total of M×(M×2) wavelength band multiplexing units). Therefore, there is the need to deploy a large number of wavelength band conversion units, which further leads to a problem in which the production cost of a wavelength cross-connect device increases.

Note that the “2” in the above “M×2” means the S-band and the L-band, and indicates the number of the bands other than the C-band (the number of the bands based on the wavelength band of the C-band, other than the C-band). Because the S-band, the C-band, and the L-band are used in this example, the number of the bands other than the C-band is “2” as described above. However, this concept also applies to the number of the bands in the case of a plurality of wavelength bands different from the above example.

The present invention has been made in view of such circumstances, and it is an object to reduce the number of wavelength band conversion units to lower the production costs of a wavelength cross-connect device.

### Solution to Problem

To solve the above problem, the present invention provides a wavelength cross-connect device that performs a relay process of demultiplexing a multiple wavelength signal light into different wavelength bands for each path by a demultiplexing unit, wherein the multiple wavelength signal light is obtained by multiplexing optical signals of different wavelength bands and transmitted in multiple bands through respective optical transmission lines formed with one or a plurality of optical fibers;
rerouting the demultiplexed optical signals using a wavelength selective switch (WSS);
multiplexing the rerouted optical signals using a multiplexing unit; and
outputting the multiple wavelength signal light obtained by the multiplexing to respective paths on the output side. The wavelength cross-connect device includes: a wavelength cross connect (WXC) unit that includes the WSS, and performs the relay process of an optical signal of a predetermined specific wavelength band among the different wavelength bands; a first conversion unit that converts a first wavelength band shorter than the specific wavelength band into an optical signal of the specific wavelength band, and converts the specific wavelength band output from the WXC unit into an optical signal of a second wavelength band longer than the specific wavelength band, among the respective wavelength bands demultiplexed by the demultiplexing unit; and a second conversion unit that converts the second wavelength band into an optical signal of the specific wavelength band, and converts the specific wavelength band output from the WXC unit into an optical signal of the first wavelength band, among the respective wavelength bands demultiplexed by the demultiplexing unit. The first conversion unit outputs to the WXC unit the optical signal of the specific wavelength band converted from the first wavelength band, and outputs to the multiplexing unit the optical signal of the second wavelength band converted from the specific wavelength band. The second conversion unit outputs to the WXC unit the optical signal of the specific wavelength band converted from the second wavelength band, and outputs to the multiplexing unit the optical signal of the first wavelength band converted from the specific wavelength band.

### Advantageous Effects of Invention

According to the present invention, it is possible to reduce the number of wavelength band conversion units and lower the production cost of the wavelength cross-connect device.

### BRIEF DESCRIPTION OF DRAWINGS

FIG. 1 is a block diagram illustrating a configuration of a wavelength cross-connect device according to an embodiment of the present invention.

FIG. 2 is a block diagram illustrating a configuration of a WXC unit of the wavelength cross-connect device according to the embodiment.

FIG. 3 is a diagram for illustrating WSSs of the WXC unit and one pair of conversion modules relating to a first path in the wavelength cross-connect device according to the embodiment.

FIG. 4 is a diagram illustrating signals of input wavelength bands to and signals of output wavelength bands from wavelength band conversion units of the conversion module.

FIG. 5 is a flowchart for explaining a wavelength cross-connect operation performed by the wavelength cross-connect device according to the embodiment.

### DESCRIPTION OF EMBODIMENTS

Hereinbelow, description is given of an embodiment of the present invention with reference to the drawings. Note that components having corresponding functions are denoted by the same reference numerals in all the drawings of the present specification, and explanation of them are not repeated as appropriate.

### Configuration of Embodiment

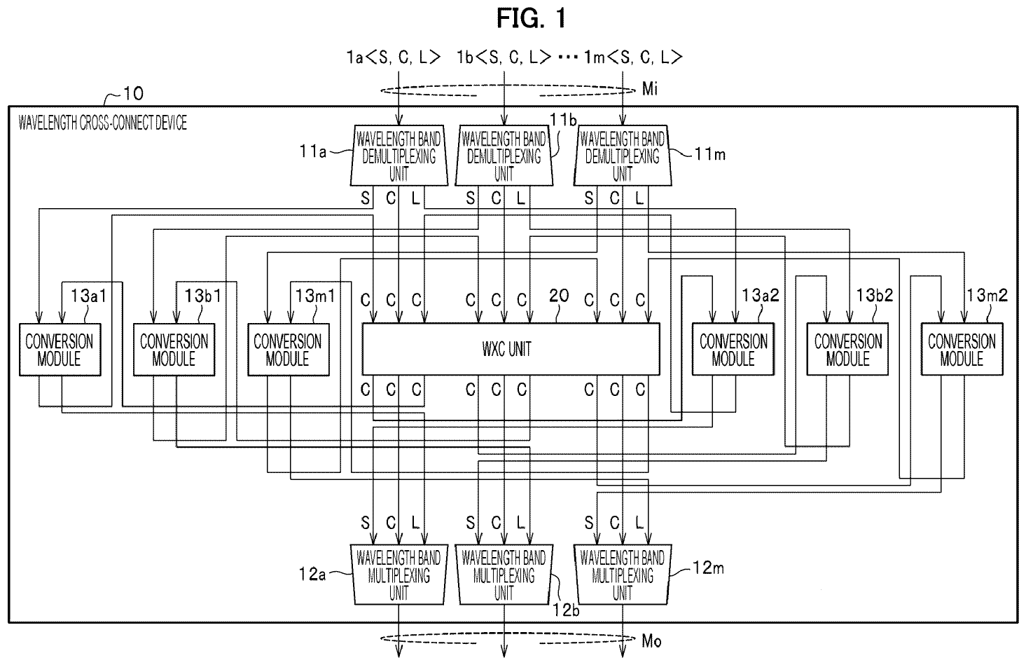

FIG. 1 is a block diagram illustrating a configuration of a wavelength cross-connect device used in a multiband transmission system according to an embodiment of the present invention.

A wavelength cross-connect device 10 illustrated in FIG. 1 includes M wavelength band demultiplexing units (also referred to as demultiplexing units) 11a, 11b, . . . , and 11m connected to respective M paths denoted by reference sign Mi on the input side, and M wavelength band multiplexing units (also referred to as the multiplexing units) 12a, 12b, . . . , and 12m connected to respective M paths denoted by reference sign Mo on the output side. Note that each of the M paths Mi is formed with one or a plurality of optical fibers. Note that the wavelength band demultiplexing units 11a to 11m form a demultiplexing unit of the claims. The wavelength band multiplexing units 12a to 12m form a multiplexing unit of the claims.

The wavelength cross-connect device 10 further includes a WXC unit 20, and M pairs of conversion modules 13a1 and 13a2, conversion modules 13b1 and 13b2, and conversion modules 13m1 and 13m2, between the demultiplexing units 11a to 11m and the multiplexing units 12a to 12m, the WXC unit 20 and M pairs of conversion modules are connected respectively with the demultiplexing units and the multiplexing units via optical fibers. All these conversion modules are collectively referred to as the conversion modules 13a1 to 13m2. Note that the conversion modules 13a1 to 13m1 form the first conversion unit of the claims. The conversion modules 13a2 to 13m2 form the second conversion unit of the claims.

Among the M input/output-side paths Mi and Mo, the path in which a multiple wavelength signal light 1a is transmitted in multiple bands is referred to as the first path, the path in which a multiple wavelength signal light 1b is transmitted in multiple bands is referred to as the second path, and the path in which a multiple wavelength signal light 1m is transmitted in multiple bands is referred to as the Mth path. Optical signals of the S-band, C-band, and L-band are respectively multiplexed into each of the multiple wavelength signal light 1a to 1m.

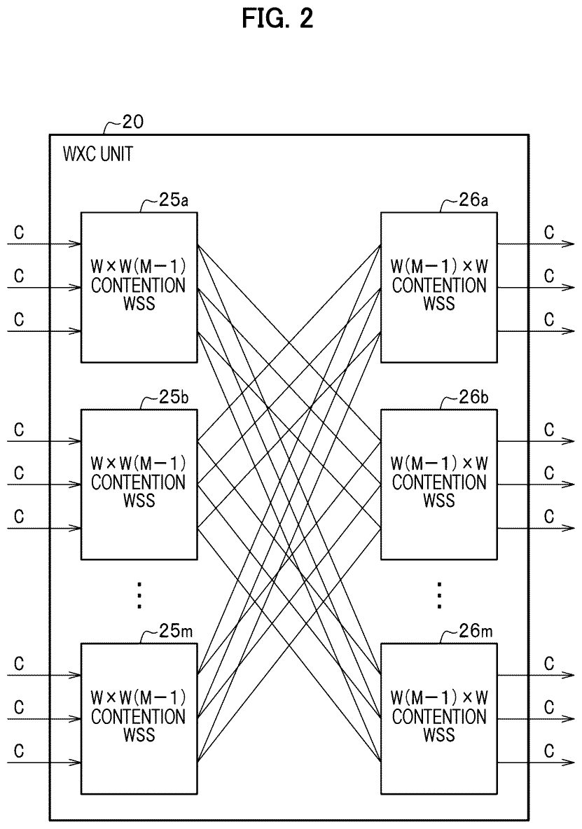

As illustrated in FIG. 2, the WXC unit 20 can process only a wavelength in a predetermined specific wavelength band (the C-band in this embodiment). The WXC unit 20 includes M of W×W(M−1) contention WSSs (also referred to as WSSs) 25a, 25b, and 25m on the input side, and M of W(M−1)×W contention WSSs 26a, 26b, . . . , and 26m on the output side.

As for W×W(M−1) or W(M−1)×W in the above expression, W represents the number of wavelength bands, and in the present embodiment, represents the three wavelength bands of the S-band, the C-band, and the L-band. M represents the number of paths at one port that is either an input port or an output port of each of the WSSs 25a to 25m and each of the WSSs 26a to 26m. This number of paths is two in this embodiment, because there are at least two paths at one port, for example as indicated at the three output ports of the WSS 25a.

In view of the above definition, the first term “W” of “W×W(M−1)” of the WSSs 25a to 25m on the input side represents the number of input ports and equals three, because the number of wavelength bands is three. The second term “W(M−1)” represents the number of output ports and equals three, because 3(2−1)=3. Two signals of the same wavelength band are output through each one port of the three output ports.

The first term W(M−1) of W(M−1)×W of the WSSs 26a to 26m on the output side represents the number of input ports, which is three, because 3(2−1)=3. Two signals of different wavelength bands are input to each one port of these three input ports. The second term “W” represents the number of output ports, which is three in this embodiment.

Meanwhile, the input ports and the output ports of each of the WSSs 25a to 25m and 26a to 26m are defined as a first input port, a second input port, and a third input port in this order from the top, and a first output port, a second output port, and a third output port in this order from the top. The first output port of the WSS 25a on the input side is connected to the first input ports of the WSS 26b and the WSS 26m on the output side. The second output port of the WSS 25a on the input side is connected to the second input ports of the WSS 26b and the WSS 26m on the output side. The third output port of the WSS 25a on the input side is connected to the third input ports of the WSS 26b and the WSS 26m on the output side.

In other words, the first input port of the WSS 26b on the output side, for example, is connected to the first output ports of the WSS 25a and the WSS 25m on the input side. That is, the connection is made so that two optical signals of the same wavelength band after demultiplexing performed by the demultiplexing units 11a to 11m are input to the first input port of the WSS 26b on the output side. Likewise, the other WSSs 25b to 25m and WSSs 26b to 26m are connected as indicated by connection lines in the drawings.

The WSSs 25a to 25m and the WSSs 26a to 26m connected in the above-described manner reroute the C-band optical signals obtained by converting the S-band and L-band optical signals of the multiple wavelength signal light 1a to 1m from the respective input paths Mi using the respective conversion modules 13a1 to 13m2, and the unconverted C-band optical signals of the multiple wavelength signal light 1a to 1m.

The contention WSS has a plurality of input ports and a plurality of output ports, and has functions of selecting optical signals in the respective wavelength bands, adjusting attenuation amounts, and the like. Further, as described above, the contention WSS has a function of processing input of a plurality {W or W(M−1)} and output of a plurality {W(M−1) or W} of optical signals. However, in a case in which optical signals of the same wavelength are input to a plurality of input ports, collisions (contentions) among the optical signals occur. Therefore, the contention WSS is configured so that any contention does not occur.

For example, the WSS 25a inputs to the first to third input ports optical signals of the C-band, whose wavelength multiplexing numbers are 96 wavelengths that includes wavelengths λ1 to λ96, but is configured such that the same wavelength is not simultaneously input to the three input ports. In other words, the WSS 25a is configured such that C-band optical signals of different wavelengths from one another are simultaneously input to the three input ports. For example, the WSS 25a is configured such that an optical signal of the C-band wavelength λ1 is input to the first input port, an optical signal of the C-band wavelength λ2 is input to the second input port, and an optical signal of the C-band wavelength λ3 is input to the third input port. Note that the WXC unit 20 may use a WSS other than the contention WSS.

The demultiplexing unit 11a illustrated in FIG. 1 demultiplexes the multiple wavelength signal light 1a transmitted in multiple bands to the first path on the input side into S-band, C-band, and L-band optical signals, outputs the S-band optical signal to the conversion module 13a1, the C-band optical signal to the WXC unit 20, and the L-band optical signal to the conversion module 13a2. The demultiplexing unit 11b demultiplexes the multiple wavelength signal light 1b transmitted to the first path into the S-band, C-band, and L-band optical signals, outputs the S-band optical signal to the conversion module 13b1, the C-band optical signal to the WXC unit 20, and the L-band optical signal to the conversion module 13b2. The demultiplexing unit 11m demultiplexes the multiple wavelength signal light 1m transmitted to the Mth path into the S-band, C-band, and L-band optical signals, outputs the S-band optical signal to the conversion module 13m1, the C-band optical signal to the WXC unit 20, and the L-band optical signal to the conversion module 13m2.

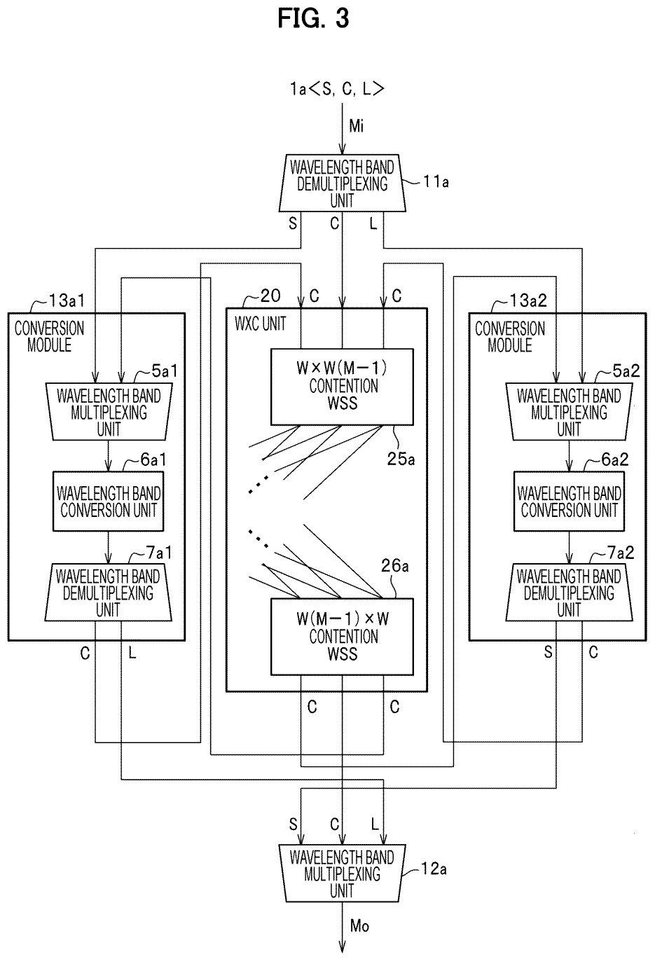

Next, description is given of process to be performed by the WXC unit 20 and the conversion modules 13a1 to 13m2, taking as a representative example the WSSs 25a and 26a of the WXC unit 20 and the conversion modules 13a1 and 13a2 of the first path illustrated in FIG. 3. Note that all the conversion modules 13a1 to 13m2 have the same configuration.

As illustrated in FIG. 3, the conversion module 13a1 includes a wavelength band multiplexing unit 5a1, a wavelength band conversion unit 6a1, and a wavelength band demultiplexing unit 7a1, and the conversion module 13a2 includes a wavelength band multiplexing unit 5a2, a wavelength band conversion unit 6a2, and a wavelength band demultiplexing unit 7a2.

Note that the wavelength band multiplexing unit 5a1 forms the first wavelength band multiplexing unit of the claims; the wavelength band conversion unit 6a1 forms the first wavelength band conversion unit of the claims; the wavelength band demultiplexing unit 7a1 forms the first wavelength band demultiplexing unit of the claims; the wavelength band multiplexing unit 5a2 forms the second wavelength band multiplexing unit of the claims; the wavelength band conversion unit 6a2 forms the second wavelength band conversion unit of the claims; the wavelength band demultiplexing unit 7a2 forms the second wavelength band demultiplexing unit of the claims.

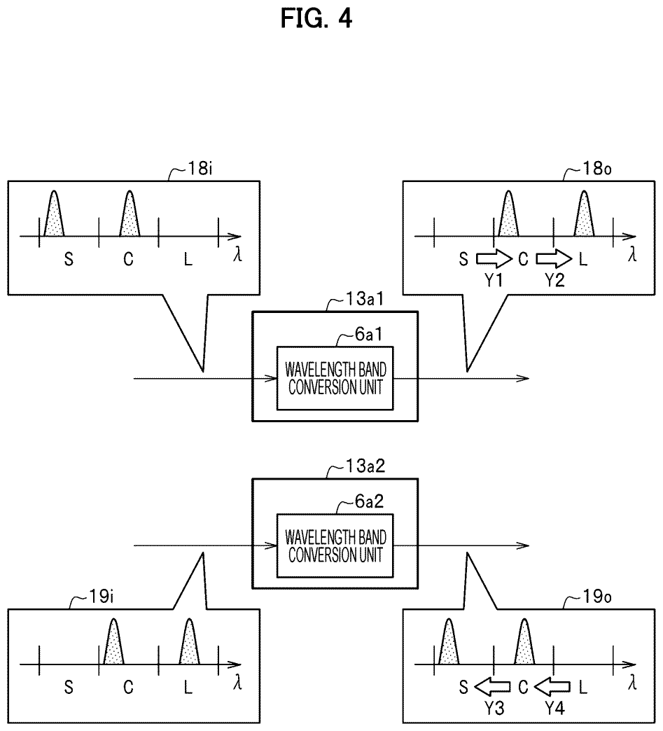

In the conversion module 13a1, the wavelength band multiplexing unit 5a1 sequentially selects the S-band optical signal demultiplexed by the demultiplexing unit 11a and the C-band optical signal output from the third output port of the WSS 26a of the WXC unit 20, and outputs the selected signals to the wavelength band conversion unit 6a1. These output S-band and C-band optical signals are illustrated in this order in a frame 18i in FIG. 4.

Next, the wavelength band conversion unit 6a1 (see FIG. 3) shifts the S-band optical signal to the long-wavelength side by the amount equivalent to one wavelength band to convert the S-band optical signal into a C-band optical signal as indicated by an arrow Y1 in a frame 180, and then shifts the C-band optical signal to the long-wavelength side by the amount equivalent to one wavelength band to convert the C-band optical signal into an L-band optical signal as indicated by an arrow Y2. These converted C-band and L-band optical signals are output to the demultiplexing unit 7a1.

The demultiplexing unit 7a1 outputs the C-band optical signal input in the output order from the first output port to the first input port of the WSS 25a of the WXC unit 20, and outputs the next L-band optical signal from the second output port to the third input port of the multiplexing unit 12a.

Next, in the conversion module 13a2, the wavelength band multiplexing unit 5a2 sequentially selects the C-band optical signal output from the first output port of the WSS 26a of the WXC unit 20 and the L-band optical signal demultiplexed by the demultiplexing unit 11a, and outputs the selected signals to the wavelength band conversion unit 6a2. These output C-band and L-band optical signals are illustrated in this order in a frame 19i in FIG. 4.

Next, the wavelength band conversion unit 6a2 shifts the C-band optical signal to the short-wavelength side by the amount equivalent to one wavelength band to convert the C-band optical signal into an S-band optical signal as indicated by an arrow Y3 in a frame 190, and then shifts the L-band optical signal to the short-wavelength side by the amount equivalent to one wavelength band to convert the L-band optical signal into a C-band optical signal as indicated by an arrow Y4. These converted S-band and C-band optical signals are output to the demultiplexing unit 7a2 illustrated in FIG. 3.

The demultiplexing unit 7a2 outputs the S-band optical signal input in the output order from the first output port to the first input port of the multiplexing unit 12a, and outputs the next C-band optical signal from the second output port to the third input port of the WSS 25a of the WXC unit 20.

The C-band optical signal demultiplexed by the demultiplexing unit 11a is input to the second input port of the WSS 25a without conversion. The C-band optical signal is output from the second output port of the WSS 26a on the output side directly to the second input port of the multiplexing unit 12a.

### Operation According to the Embodiment

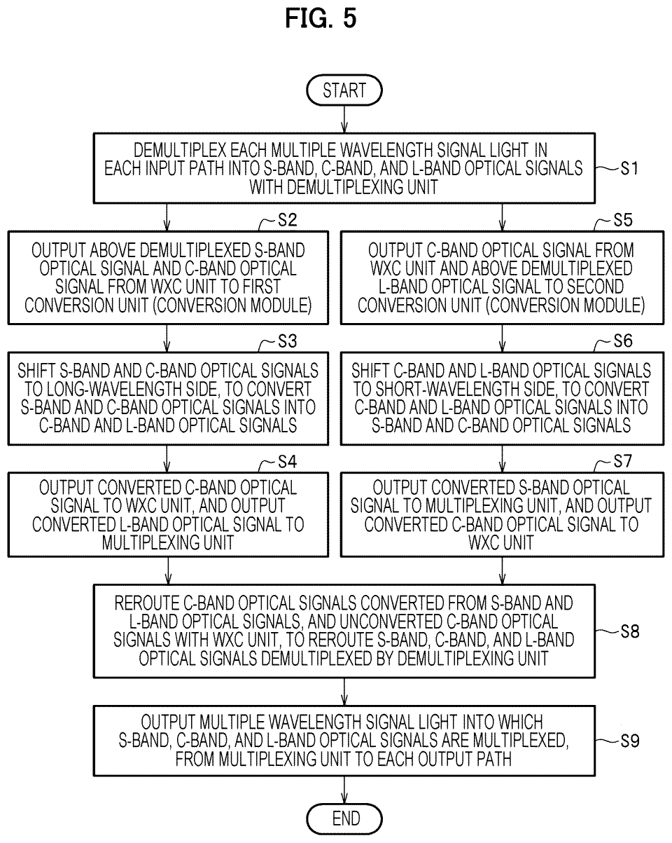

Next, description is given of a wavelength cross-connect operation performed by the wavelength cross-connect device 10 according to the present embodiment with reference to a flowchart shown in FIG. 5.

In step S1 shown in FIG. 5, multiple wavelength signal light 1a to 1m transmitted in multiple bands via the respective M input paths illustrated in FIG. 1 are input to input ports of the M demultiplexing units 11a to 11m. Note that optical signals of the S-band, C-band, and L-band are multiplexed into each of the multiple wavelength signal light 1a to 1m.

The respective demultiplexing units 11a to 11m demultiplex the respective optical signals of the S-band, the C-band and the L-band in each of the multiple wavelength signal light 1a to 1m, output the demultiplexed S-band optical signals to the conversion modules 13a1 to 13m1, each of which is one conversion module in a pair, the C-band optical signals to the WXC unit 20, and the L-band optical signals to the conversion modules 13a2 to 13m2, each of which is the other one conversion module in a pair.

The wavelength band conversion processes performed by the WXC unit 20 and the M pairs of conversion modules 13a1 to 13m2, to which these S-band, C-band, and L-band optical signals are output, are described, taking as representative examples the WSSs 25a and 26a of the WXC unit 20 and one pair of conversion modules 13a1 and 13a2 of the first path Mi illustrated in FIG. 3.

After the process in step S1, a series of processes in steps S2, S3, and S4, and a series of processes in steps S5, S6, and S7 are carried out in parallel, and the process then moves on to step S8.

In step S2, the wavelength band multiplexing unit 5a1 of the conversion module 13a1 selects the S-band optical signal demultiplexed by the demultiplexing unit 11a and the C-band optical signal output from the third output port of the WSS 26a of the WXC unit 20, and outputs the selected signals to the wavelength band conversion unit 6a1, as illustrated in the frame 18i (FIG. 4).

In step S3, the wavelength band conversion unit 6a1 shifts the S-band optical signal to the long-wavelength side by the amount equivalent to one wavelength band to convert the S-band optical signal into a C-band optical signal as indicated by the arrow Y1 in the frame 180 (FIG. 4), and then shifts the C-band optical signal to the long-wavelength side by the amount equivalent to one wavelength band to convert the C-band optical signal into an L-band optical signal as indicated by the arrow Y2. These converted C-band and L-band optical signals are output to the demultiplexing unit 7a1.

In step S4, the demultiplexing unit 7a1 outputs the C-band optical signal input in the output order from the first output port to the first input port of the WSS 25a of the WXC unit 20, and outputs the next input L-band optical signal from the second output port to the third input port of the multiplexing unit 12a.

In step S5, the wavelength band multiplexing unit 5a2 of the conversion module 13a2 selects the C-band optical signal output from the first output port of the WSS 26a of the WXC unit 20 and the L-band optical signal demultiplexed by the demultiplexing unit 11a, and outputs the selected signals to the wavelength band conversion unit 6a2, as illustrated in the frame 19i (FIG. 4).

In step S6, the wavelength band conversion unit 6a2 shifts the C-band optical signal to the short-wavelength side by the amount equivalent to one wavelength band to convert the C-band optical signal into an S-band optical signal as indicated by the arrow Y3 in the frame 190 (FIG. 4), and then shifts the L-band optical signal to the short-wavelength side by the amount equivalent to one wavelength band to convert the L-band optical signal into a C-band optical signal as indicated by the arrow Y4. These converted S-band and C-band optical signals are output to the demultiplexing unit 7a2.

In step S7, the demultiplexing unit 7a2 outputs the S-band optical signal input in the output order from the first output port to the first input port of the multiplexing unit 12a, and outputs the next input C-band optical signal from the second output port to the third input port of the WSS 25a.

In step S8, the C-band optical signal demultiplexed by the demultiplexing unit 11a is input to the second input port of the WSS 25a without conversion. The C-band optical signal is output from the second output port of the WSS 26a on the output side directly to the second input port of the multiplexing unit 12a.

Here, the C-band optical signals obtained by converting the S-band and L-band optical signals as described above, and the unconverted C-band optical signal are input to the respective input ports of the WSS 25a, and are output from the respective output ports of the WSS 25a to the predetermined output-side WSSs 26b and 26m (FIG. 2). Thus, the S-band, C-band, and L-band optical signals are rerouted.

In step S9, like the multiplexing unit 12a described as the representative example, each of the multiplexing units 12a to 12m (FIG. 1), to which optical signals of the S-band, C-band, and L-band are input, outputs a multiple wavelength signal light obtained by multiplexing the respective optical signals of the S-band, the C-band, and the L-band to each corresponding one of the M output paths.

### Effects of Embodiment

Description is given of effects of the wavelength cross-connect device 10 according to the embodiment of the present invention.

The wavelength cross-connect device 10 demultiplexes the multiple wavelength signal light 1a to 1m, into which optical signals of different wavelength bands (the S-band, the C-band, and the L-band) transmitted in multiple bands are multiplexed, into different wavelength bands using the demultiplexing units 11a to 11m for the respective paths in the respective optical transmission lines each formed with one or a plurality of optical fibers. The demultiplexed optical signals of the respective wavelength bands are rerouted by the input-side WSSs 21a to 21m and the output-side WSSs 22a to 22m as the WSSs and then multiplexed at the multiplexing units 12a to 12m, and the multiple wavelength signal light obtained by the multiplexing are output to the respective paths on the output side. Such processes perform the relay process.

(1a) The wavelength cross-connect device 10 includes the WXC unit 20 that has the input-side WSSs 21a to 21m and the output-side WSSs 22a to 22m and that performs the relay process of optical signals of the predetermined specific wavelength band (the C-band) among the different wavelength bands.

The wavelength cross-connect device 10 includes a first conversion unit (the conversion module 13a1) that converts a first wavelength band (the S-band) shorter than the specific wavelength band among the respective wavelength bands demultiplexed by the demultiplexing units 11a to 11m into an optical signal of the specific wavelength band (the C-band) and that converts the specific wavelength band (the C-band) output from the WXC unit 20 into an optical signal of a second wavelength band (the L-band) longer than the specific wavelength band.

The wavelength cross-connect device 10 further includes a second conversion unit (the conversion module 13a2) that converts the second wavelength band (the L-band) among the respective demultiplexed wavelength bands into an optical signal of the specific wavelength band (the C-band), and converts the specific wavelength band (the C-band) output from the WXC unit 20 into an optical signal of the first wavelength band (the S-band).

Further, the first conversion unit outputs the optical signal of the specific wavelength band (the C-band) converted from the first wavelength band to the WXC unit 20, and outputs the optical signal of the second wavelength band (the L-band) to the multiplexing unit 12a. The second conversion unit outputs the optical signal of the specific wavelength band (the C-band) converted from the second wavelength band to the WXC unit 20, and outputs the optical signal of the first wavelength band (the S-band) to the multiplexing unit 12a.

With this configuration, only the first and second conversion units (the conversion modules 13a1 and 13a2) that are conversion units for two wavelength band are used for one pair of the demultiplexing unit 11a and the multiplexing unit 12a. In conventional configuration, two wavelength band conversion units are used for the one demultiplexing unit 11a, and two wavelength band conversion units are used for the one multiplexing unit 12a. In other words, it is necessary to use four wavelength band conversion units for the one pair of the demultiplexing unit 11a and the multiplexing unit 12a. Accordingly, in the wavelength cross-connect device 10 of the present embodiment, the number (two) of the wavelength band conversion units (the conversion modules 13a1 and 13a2) to be used is half comparing the conventional configuration, and thus, the production cost of the wavelength cross-connect device 10 can be reduced.

(2a) The first conversion unit includes the wavelength band multiplexing unit 5a1 as the first wavelength band multiplexing unit (the first wavelength band multiplexing unit 5a1), the wavelength band conversion unit 6a1 as the first wavelength band conversion unit (the first wavelength band conversion unit 6a1), and the wavelength band demultiplexing unit 7a1 as the first wavelength band demultiplexing unit (the first wavelength band demultiplexing unit 7a1).

The first wavelength band multiplexing unit 5a1 outputs the optical signal of the first wavelength band (the S-band) demultiplexed by the demultiplexing unit 11a and the optical signal of the specific wavelength band (the C-band) output from the WXC unit 20. The first wavelength band conversion unit 6a1 shifts the output S-band optical signal and C-band optical signal to the long-wavelength side by the amount equivalent to one wavelength band, converts the first wavelength band into an optical signal of the specific wavelength band (the C-band), and converts the specific wavelength band output from the WXC unit 20 into an optical signal of the second wavelength band (the L-band). The first wavelength band demultiplexing unit 7a1 outputs the optical signal of the specific wavelength band (the C-band) converted from the first wavelength band to the multiplexing unit 12a, and outputs the optical signal of the second wavelength band (the L-band) converted from the specific wavelength band to the WXC unit 20.

The second conversion unit includes the wavelength band multiplexing unit 5a2 as the second wavelength band multiplexing unit (the second wavelength band multiplexing unit 5a2), the wavelength band conversion unit 6a2 as the second wavelength band conversion unit (the second wavelength band conversion unit 6a2), and the wavelength band demultiplexing unit 7a2 as the second wavelength band demultiplexing unit (the second wavelength band demultiplexing unit 7a2).

The second wavelength band multiplexing unit 5a2 outputs the optical signal of the second wavelength band demultiplexed by the demultiplexing unit 11a and the optical signal of the specific wavelength band output from the WXC unit. The second wavelength band conversion unit 6a2 shifts the output optical signal of the second wavelength band and the output optical signal of the specific wavelength band to the short-wavelength side by the amount equivalent to one wavelength band, converts the second wavelength band (the L-band) into an optical signal of the specific wavelength band (the C-band), and converts the specific wavelength band (the C-band) output from the WXC unit 20 into an optical signal of the first wavelength band (the S-band). The second wavelength band demultiplexing unit 7a2 outputs the optical signal of the specific wavelength band (the C-band) converted from the second wavelength band to the WXC unit 20, and outputs the optical signal of the first wavelength band (the S-band) converted from the specific wavelength band to the multiplexing unit.

With this configuration, each of the first and second conversion units includes a wavelength band multiplexing unit and a wavelength band demultiplexing unit, in addition to a wavelength band conversion unit. Because a wavelength band multiplexing unit and a wavelength band demultiplexing unit are much less expensive than a wavelength band conversion unit, the first and second conversion units can be formed at low costs. Thus, the production cost of the wavelength cross-connect device can be reduced.

### Effects

(1) A wavelength cross-connect device performs a relay process of demultiplexing a multiple wavelength signal light into different wavelength bands for each path using a demultiplexing unit, wherein the multiple wavelength signal light is obtained by multiplexing optical signals of different wavelength bands and transmitted in multiple bands through respective optical transmission lines formed with one or a plurality of optical fibers; rerouting the demultiplexed optical signals of the respective wavelength bands using a wavelength selective switch (WSS); multiplexing the rerouted optical signals using a multiplexing unit; and outputting the multiple wavelength signal light obtained by the multiplexing to each path on an output side. The wavelength cross-connect device includes: a wavelength cross connect (WXC) unit that includes the WSS, and performs the relay process of an optical signal of a predetermined specific wavelength band among different wavelength bands; a first conversion unit that converts a first wavelength band shorter than the specific wavelength band into an optical signal of the specific wavelength band, and converts the specific wavelength band output from the WXC unit into an optical signal of a second wavelength band longer than the specific wavelength band, among the respective wavelength bands demultiplexed by the demultiplexing unit; and a second conversion unit that converts the second wavelength band into an optical signal of the specific wavelength band, and converts the specific wavelength band output from the WXC unit into an optical signal of the first wavelength band, among the respective wavelength bands demultiplexed by the demultiplexing unit. The first conversion unit outputs the optical signal of the specific wavelength band converted from the first wavelength band to the WXC unit, and outputs the optical signal of the second wavelength band converted from the specific wavelength band to the multiplexing unit. The second conversion unit outputs the optical signal of the specific wavelength band converted from the second wavelength band to the WXC unit, and outputs the optical signal of the first wavelength band converted from the specific wavelength band to the multiplexing unit.

With this configuration, only two wavelength band conversion units (the first and second conversion units) are used for one pair of a demultiplexing unit and a multiplexing unit. In conventional configuration, two wavelength band conversion units are used for one demultiplexing unit, and two wavelength band conversion units are used for one multiplexing unit. In other words, it is necessary to use four wavelength band conversion units for one pair of a demultiplexing unit and a multiplexing unit. Accordingly, in the wavelength cross-connect device of the present invention, the number of the wavelength band conversion units to be used is half of the conventional configuration, and thus, the production cost of the wavelength cross-connect device can be reduced.

(2) In the wavelength cross-connect device of (1), the first conversion unit includes: a first wavelength band multiplexing unit that outputs the optical signal of the first wavelength band demultiplexed by the demultiplexing unit, and the optical signal of the specific wavelength band from the WXC unit; a first wavelength band conversion unit that shifts the output optical signal of the first wavelength band and the output optical signal of the specific wavelength band to a long-wavelength side by the amount equivalent to one wavelength band, to convert the first wavelength band into an optical signal of the specific wavelength band, and convert the specific wavelength band from the WXC unit into an optical signal of the second wavelength band; and a first wavelength band demultiplexing unit that outputs the optical signal of the specific wavelength band converted from the first wavelength band to the WXC unit, and outputs the optical signal of the second wavelength band converted from the specific wavelength band to the multiplexing unit, and the second conversion unit includes: a second wavelength band multiplexing unit that outputs the optical signal of the second wavelength band demultiplexed by the demultiplexing unit, and the optical signal of the specific wavelength band from the WXC unit; a second wavelength band conversion unit that shifts the output optical signal of the second wavelength band and the output optical signal of the specific wavelength band to a short-wavelength side by the amount equivalent to one wavelength band, to convert the second wavelength band into an optical signal of the specific wavelength band, and convert the specific wavelength band from the WXC unit into an optical signal of the first wavelength band; and a second wavelength band demultiplexing unit that outputs the optical signal of the specific wavelength band converted from the second wavelength band to the WXC unit, and outputs the optical signal of the first wavelength band converted from the specific wavelength band to the multiplexing unit.

With this configuration, each of the first and second conversion units includes a wavelength band multiplexing unit and a wavelength band demultiplexing unit, in addition to a wavelength band conversion unit. Because the wavelength band multiplexing unit and the wavelength band demultiplexing unit are much less expensive than the wavelength band conversion unit, the first and second conversion units can be formed at low cost. Thus, the production cost of the wavelength cross-connect device can be reduced.

In addition to the above configuration, the detailed configuration can be modified as appropriate, without departing from the scope of the present invention.

### REFERENCE SIGNS LIST

10: Wavelength cross-connect device
11a to 11m: Wavelength band demultiplexing unit (demultiplexing unit)
12a to 12m: Wavelength band multiplexing unit (multiplexing unit)
13a1, 13b1, 13m1: Conversion module (first conversion unit)
13a2, 13b2, 13m2: Conversion module (second conversion unit)
5a1: Wavelength band multiplexing unit (first wavelength band multiplexing unit)
5a2: Wavelength band multiplexing unit (second wavelength band multiplexing unit)
6a1: Wavelength band conversion unit (first wavelength band conversion unit)
6a2: Wavelength band conversion unit (second wavelength band conversion unit)
7a1: Wavelength band demultiplexing unit (first wavelength band demultiplexing unit)
7a2: Wavelength band demultiplexing unit (second wavelength band demultiplexing unit)
20: WXC unit
25a to 25m, 26a to 26m: Contention WSS (WSS)

1. A wavelength cross-connect device configured to perform a relay process of:
demultiplexing a multiple wavelength signal light into different wavelength bands for each path using a demultiplexing unit, wherein the multiple wavelength signal light is obtained by multiplexing optical signals of the different wavelength bands and transmitted in multiple bands through respective optical transmission lines formed with one or a plurality of optical fibers;
rerouting the demultiplexed signal light using a wavelength selective switch (WSS);
multiplexing the rerouted signal light using a multiplexing unit; and
outputting a multiple wavelength signal light obtained by the multiplexing to respective paths on the output side,
the wavelength cross-connect device comprising:
a wavelength cross connect (WXC) unit that includes the WSS, and configured to perform the relay process of an optical signal of a predetermined specific wavelength band among the different wavelength bands;
a first conversion unit configured to convert a first wavelength band shorter than the specific wavelength band into an optical signal of the specific wavelength band, and convert the specific wavelength band output from the WXC unit into an optical signal of a second wavelength band longer than the specific wavelength band, among respective wavelength bands demultiplexed by the demultiplexing unit; and
a second conversion unit configured to convert the second wavelength band into an optical signal of the specific wavelength band, and convert the specific wavelength band output from the WXC unit into an optical signal of the first wavelength band, among the respective wavelength bands demultiplexed by the demultiplexing unit, wherein
the first conversion unit configured to output the optical signal of the specific wavelength band converted from the first wavelength band to the WXC unit, and output the optical signal of the second wavelength band converted from the specific wavelength band to the multiplexing unit, and
the second conversion unit configured to output the optical signal of the specific wavelength band converted from the second wavelength band to the WXC unit, and output the optical signal of the first wavelength band converted from the specific wavelength band to the multiplexing unit.

2. The wavelength cross-connect device according to claim 1,
wherein the first conversion unit includes:
a first wavelength band multiplexing unit configured to output the optical signal of the first wavelength band demultiplexed by the demultiplexing unit, and the optical signal of the specific wavelength band from the WXC unit;
a first wavelength band conversion unit configured to shift the output optical signal of the first wavelength band and the output optical signal of the specific wavelength band to a long-wavelength side by an amount equivalent to one wavelength band, to convert the first wavelength band into an optical signal of the specific wavelength band, and convert the specific wavelength band from the WXC unit into an optical signal of the second wavelength band; and
a first wavelength band demultiplexing unit configured to output the optical signal of the specific wavelength band converted from the first wavelength band to the WXC unit, and output the optical signal of the second wavelength band converted from the specific wavelength band to the multiplexing unit, and
the second conversion unit includes:
a second wavelength band multiplexing unit configured to output the optical signal of the second wavelength band demultiplexed by the demultiplexing unit, and the optical signal of the specific wavelength band from the WXC unit;
a second wavelength band conversion unit configured to shift the output optical signal of the second wavelength band and the output optical signal of the specific Page wavelength band to a short-wavelength side by an amount equivalent to one wavelength band, to convert the second wavelength band into an optical signal of the specific wavelength band, and convert the specific wavelength band from the WXC unit into an optical signal of the first wavelength band; and
a second wavelength band demultiplexing unit configured to output the optical signal of the specific wavelength band converted from the second wavelength band to the WXC unit, and output the optical signal of the first wavelength band converted from the specific wavelength band to the multiplexing unit.

3. A wavelength cross-connect method implemented by a wavelength cross-connect device configured to
perform a relay process of rerouting an optical signals of different wavelength bands using a wavelength selective switch (WSS), the optical signals of the different wavelength bands being obtained by demultiplexing a multiple wavelength signal light into different wavelength bands using a demultiplexing unit for each path, the multiple wavelength signal light being obtained by multiplexing optical signals of different wavelength bands and being transmitted in multiple bands in each optical transmission line formed with one or a plurality of optical fibers; multiplexing the rerouted optical signals of wavelength bands into a multiple wavelength signal light using a multiplexing unit; and outputting the multiple wavelength signal light obtained by the multiplexing to each path on an output side,
wherein the wavelength cross-connect device includes a WXC unit that includes the WSS and performs the relay process of an optical signal of a predetermined specific wavelength band among the different wavelength bands,
the wavelength cross-connect method comprising:
sequentially shifting an optical signal of a wavelength band other than the specific wavelength band among the demultiplexed wavelength bands, and the optical signal of the specific wavelength band output from the WXC unit to a long-wavelength side by an amount equivalent to one wavelength band, to convert the optical signal of the wavelength band other than the specific wavelength band and the optical signal of the specific wavelength band into optical signals of different wavelength bands;
sequentially shifting an optical signal of a wavelength band other than the specific wavelength band among the demultiplexed wavelength bands, and the optical signal of the specific wavelength band output from the WXC unit to a short-wavelength side by an amount equivalent to one wavelength band, to convert the optical signal of the wavelength band other than the specific wavelength band and the optical signal of the specific wavelength band into optical signals of different wavelength bands;
outputting the optical signals of the wavelength bands other than the specific wavelength band converted into the different wavelength bands to the multiplexing unit, and outputting the converted optical signal of the specific wavelength band to the WXC unit; and
outputting the optical signal of the specific wavelength band among the demultiplexed wavelength bands to the multiplexing unit via the WXC unit, without conversion.
